(19) United States
(12) Patent Application Publication
(10) Pub. No.: US 2018/0344085 A1
(43) Pub. Date: Dec. 6, 2018

(54) Cooking Rack

(71) Applicant: Fred Dutter, Sparks, NV (US)

(72) Inventor: Fred Dutter, Sparks, NV (US)

(21) Appl. No.: 16/000,508

(22) Filed: Jun. 5, 2018

Related U.S. Application Data
(60) Provisional application No. 62/515,843, filed on Jun. 6, 2017.

(51) Int. Cl. A47J 37/06; A47J 37/07; F24C 15/16

(52) U.S. Cl. CPC A47J 37/0694; A47J 37/0664; F24C 15/16; A47J 37/0786

(57) ABSTRACT

The present invention comprises a cooking rack including plate; a plurality of holes formed in the plate; a plurality of legs for supporting the plate above a surface. The plurality of holes and plurality of legs may be configured to enhance the amount of radiative heat that an item placed on top of the plate can receive. Further, the plurality of holes may account for at least 40% of an area of the plate. The invention may further include a plurality of legs provide a contact surface that is less than 3% of an area of the plate. Sets of legs may project from the sides of the plate.

### FIELD OF THE INVENTION

The present invention relates to cooking racks which may be used, for example, as a broiling rack, backing rack, smoking rack, roasting rack, steamer or trivet.

### BACKGROUND

Cooking racks are used in various cooking vessels such as pots, camp ovens, Dutch ovens and the like and provide a means for spacing the food to be cooked from the base of the cooking vessel. This ensures that the food is cooked by radiative heat from the surfaces of the vessel. including the top, bottom and walls of the vessel, and convective heat from air flow around the food rather than from direct conductive heat through the vessel from an external heat source such as a fire, heat beads, charcoal, etc. Otherwise, if the food is provided directly on the base of the cooking vessel, the food has a tendency to burn due to the direct heating from the cooking vessel, or at least does not cook evenly through the food.

Many racks do not properly provide a good surface for cooking with the best radiant and air flow properties. What is required is an improved cooking rack.

### SUMMARY OF ONE OR MORE EMBODIMENTS OF THE INVENTION

### Advantages of One or More Embodiments of the Present Invention

The various embodiments of the present invention may, but do not necessarily, achieve one or more of the following advantages:

provides a cooking rack that allows transfer of heat to a cooking item at a more rapid and even rate;

reduces the amount of direct contact to the cooking vessel to allow for more air flow and reduce direct heat transfer to the cooking rack;

provides better air flow below the cooking rack;

provides for more even spacing of the item being cooked between the top and bottom of cooking vessel;

provides adequate space below the cooking rack to insert wood chips or similar for wood flavor;

provides better airflow around the cooked item when removed from the cooking vessel and used as a cooling rack;

provides lifting holes for use with tongs or similar lifter for facilitating removal of the cooking rack from the cooking vessel;

provides upward projecting legs to stabilize pans and the like on the surface of the rack;

provides legs of different lengths to provide multiple height selection.

These and other advantages may be realized by reference to the remaining portions of the specification, claims, and abstract.

### BRIEF DESCRIPTION OF ONE OR MORE EMBODIMENTS OF THE PRESENT INVENTION

In one embodiment, there is provided a cooking rack comprising a plate having a plurality of holes formed therein. A plurality of legs may support the plate above a surface. The plurality of holes and the plurality of legs may be configured to enhance the amount of radiative heat that an item placed on top of the plate can receive.

In one embodiment, there is provided a cooking rack comprising a plate having a plurality of holes formed therein. A first set of legs having a first length may project from a first side of the plate and a second set of legs may project from a second side of the plate. In one embodiment, the first set of legs and the second set of legs may be of equal lengths or of different lengths.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a plan view of a cooking rack in accordance with an embodiment of the invention;

FIG. 2 is substantially a perspective view of the cooking rack of FIG. 1;

FIG. 3 a first side view of a lifter for use with the cooking rack of FIG. 1;

FIG. 4 is substantially a second side view of the lifter of FIG. 3; and

FIG. 5 is substantially a perspective view of an alternative embodiment of a lifter.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

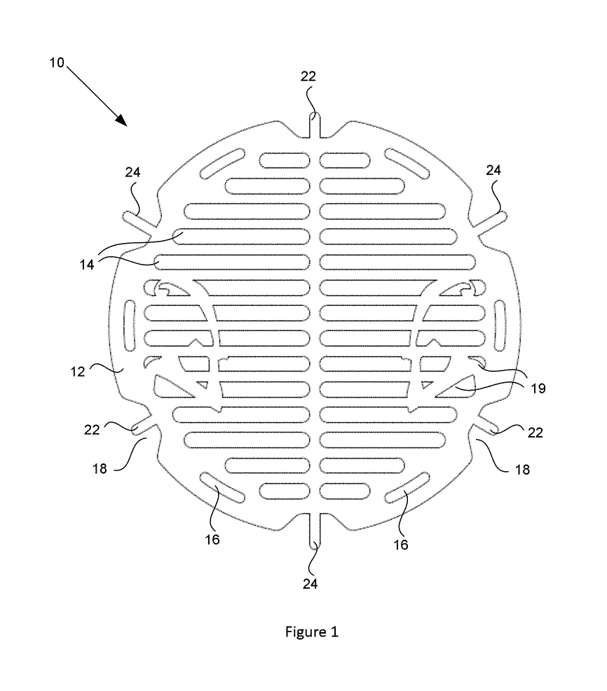

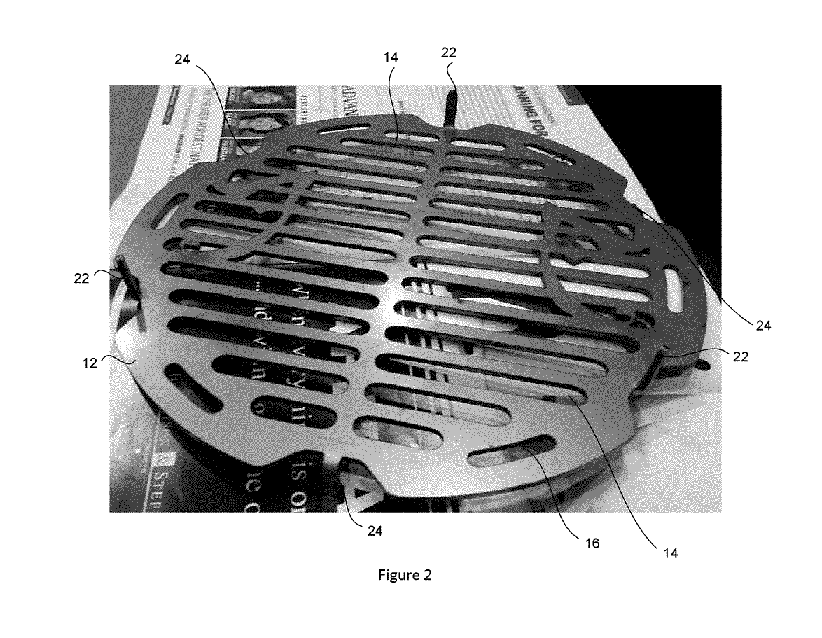

In FIG. 1, there is shown a plan view of a cooking rack 10 in accordance with an embodiment of the invention. The cooking rack 10 is shown in perspective view in FIG. 2. The terms rack, grille, or grate may be used interchangeably throughout the present description. The cooking rack 10 is a substantially flat plate 12 made from solid steel, cast iron or the like. In one embodiment, the cooking rack may have a minimum thickness of 1/12^{th} inch, (14 gauge), and in one embodiment, the cooking rack may have a maximum thickness of ⅜″. The cooking rack 10 is formed with a plurality of holes which may be formed during the casting process, or may be laser cut, punched, or formed by any suitable forming process.

The cooking rack 10 is generally circular in plan view and thus has a diameter and an overall area. The cooking rack 10 may be made in various diameters for use in different sized cooking vessels. While the plate 12 is shown as circular for use in circular pots, which are common, the person skilled in the art will readily understand that the plate 12 may be made in different shapes.

The cooking rack 10 has an overall area defined by its diameter. In one embodiment, the area of the rack 10, as defined by its diameter, is at least 85% of the diameter of the cooking vessel, e.g. pot, that it is designed to fit in. This ensures maximum cooking capacity for a given pot size. In one embodiment, the holes formed in the rack account for at least 40% of the area of the cooking rack. The benefit of a large area of holes compared to the comparable area of metal (e.g. maximum 60%) is that it allows for a greater air flow and ensures that the food item that is being cooked receives more direct radiant heat from the pot which ensures a more even and rapid cooking. FIG. 1 shows a particular hole pattern including unidirectional slots 14, circumferential slots 16, edge holes 18, and various additional holes 19. Some or all of the holes may be provided to functionally assist in the cooking process, e.g. by facilitating air flow or allowing radiant heat from the pot surfaces, including the bottom, walls and lid, to reach the food items. Alternatively or in addition, some or all of the holes may be configured to provide an aesthetically pleasing and distinctive appearance for the cooking rack 10. The person skilled in the art will recognize that other hole patterns are within the purview of the present description.

Some of all of the holes as described above may provide lifting holes that interact with a lifting device, e.g. lifting tongs, to facilitate removal of the rack 10 from a pot 10, for example when the rack is too hot to touch and/or while when there is food upon the rack 10.

The cooking rack 10 may include legs 22, 24 for supporting the rack in the cooking vessel above the bottom of the cooking vessel. The legs 22, 24 are provided toward a perimeter of the plate 12 and include a set of upward projecting legs 22 and a downward projecting set of legs 24. The first set of legs 22 have a first length and the second set of legs 24 have a second length different to the first length. The rack may therefore be reversed, i.e. flipped over, so that the height of the plate 12 above the bottom surface of the cooking vessel may be chosen. For example, a taller height may be chosen if it is desired to provide wood chips or similar smoke flavor additions beneath the rack and/or if it is desirable to have the food item located toward the middle height of the cooking vessel. The short leg length may be chosen to accommodate taller food items within the cooking vessel. In one embodiment, the first set of legs may support the plate at a height of approximately 7/16″ above the pot surface while the second set of legs may support the plate at a height of 1½″ above the pot surface.

An additional benefit of having upward projecting legs is that it provides an additional positioning mechanism that helps keep pans that are placed on the rack in the center of the rack and stabilizes the pan while removing the rack from the oven. It is therefore not essential that the first set of legs and second set of legs are of different lengths. In one or more embodiments, the first set of legs and the second set of legs may be of equal lengths.

The legs may be designed to minimize the amount of contact between the cooking rack and the cooking vessel, e.g. pot, in which the cooking rack is placed. In one embodiment, the leg design allows no more than 3% of the total surface size to be touching the pot it is placed in. For example, as seen in FIG. 2, the legs 22, 24 include a narrow strip of the plate material that projects from surface of the plate. At the distal end of the respective leg 22, 24, the leg is rounded so that only a minimal point of the leg will contact the surface on which the cooking rack is supported.

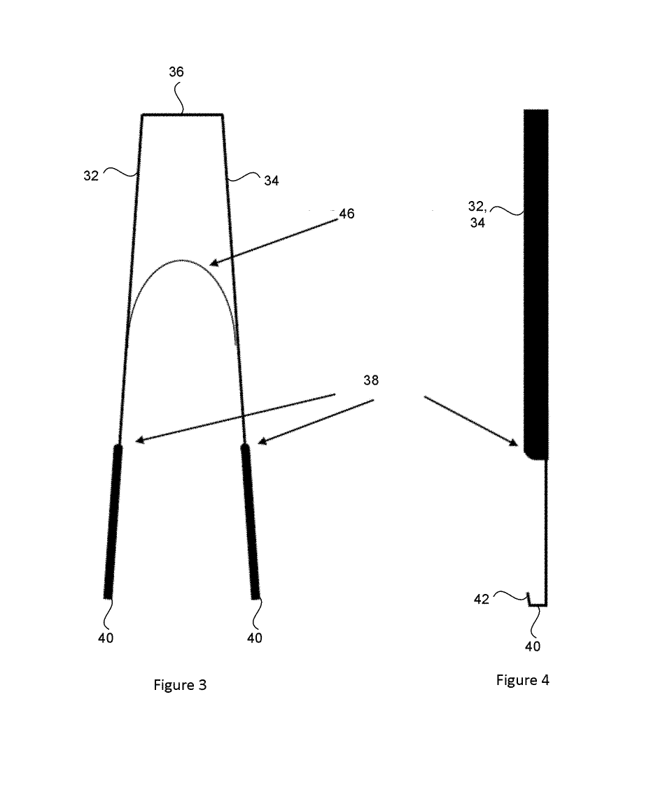

In FIGS. 3 and 4, there is shown an embodiment of a lifter that can be used with the rack 10. In one embodiment, the lifter 30 may be made of a single strip of flat steel or similar that is bent into the shape shown in FIG. 3. The tongs have two arms 32, 34 joined by an intermediate section 36. Part way down each arm, there is a 90 degree twist 38 in the strip of material. At the end of each arm 32, 34, there is a hook section 40 formed by successive folds or bends in the material strip. The outer distal section 42 of the hook is bent upward at approximately 80 degrees, as depicted in FIG. 4, though the specific angle is not considered an essential limitation of the embodiments.

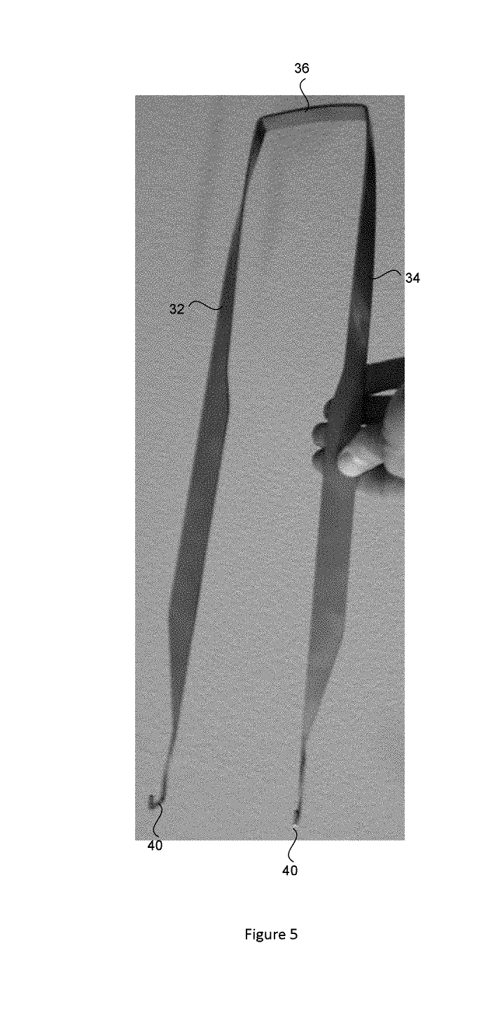

Between the two arms 32, 34, there may be affixed a curved strip 46 to provide a spring that biases the tong arms 32, 34 outward. The spring 46 may be secured to one or both of the tong arms by suitable means, such as a weld, spot weld, rivets, or the like. In an alternative embodiment (FIG. 5), the tongs 30 may be formed of spring steel, in which case the spring 46 may be omitted.

In use, the tong arms 32, 34 may be squeezed together and inserted down the internal side wall of the pot, oven etc. with the hooks together and flat against the side of the oven. Once the hooks are below the rack, the tongs may be maneuvered, e.g. by twisting or rotating, and also expanded to allow the hooks of each arm 32, 34 to move apart. The hooks can then engage openings, slots, etc. in the rack and allow the user to lift the rack out of the oven.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A cooking rack comprising:
(A) a plate;
(B) a plurality of holes formed in the plate; and
(C) a plurality of legs for supporting the plate above a surface;
(D) wherein the plurality of holes and plurality of legs are configured to enhance the amount of radiative heat that an item placed on top of the plate can receive.

2. The cooking rack of claim 1 wherein the plurality of holes account for at least 40% of an area of the plate.

3. The cooking rack of claim 1 wherein the plurality of legs provide a contact surface that is less than 3% of an area of the plate.

4. A cooking rack comprising:
(A) a plate;
(B) a plurality of holes formed in the plate;
(C) a first set of legs projecting from a first side of the plate; and
(D) a second set of legs projecting from a second side of the plate.

5. The cooking rack of claim 4 wherein the first set of legs have a first length and wherein the second set of legs have a second length that is different to the first length.
